(19) United States
(12) Patent Application Publication
(10) Pub. No.: US 2016/0082400 A1
(43) Pub. Date: Mar. 24, 2016

(54) SEPARATION MEMBRANE FOR TREATING ACID GAS-CONTAINING GAS, AND METHOD FOR MANUFACTURING SEPARATION MEMBRANE FOR TREATING ACID GAS-CONTAINING GAS

(71) Applicant: TOYO TIRE & RUBBER CO., LTD., Osaka-shi, Osaka (JP)

(72) Inventors: Tomohiko Kurahashi, Osaka-shi (JP); Koji Kuraoka, Kobe-shi (JP)

(73) Assignee: TOYO TIRE & RUBBER CO., LTD., Osaka-shi, Osaka (JP)

(21) Appl. No.: 14/888,979

(22) PCT Filed: Mar. 31, 2014
(86) PCT No.: PCT/JP2014/059412

§ 371 Date: Nov. 4, 2015

(30) Foreign Application Priority Data
Jun. 12, 2013 (JP) 2013-123448

(51) Int. Cl. B01D 71/70; B01D 67/00; C08J 9/36; B01D 53/22

(52) U.S. Cl. CPC B01D 71/70; B01D 53/228; B01D 67/0006; C08J 9/365; C08J 2383/04

(57) ABSTRACT

An acid gas-containing gas treatment separation membrane is provided which can separate acid gas, such as carbon dioxide, etc., or methane gas from biogas containing acid gas and methane gas, to obtain a gas having a high methane concentration. The acid gas-containing gas treatment separation membrane includes a polysiloxane network structure having an introduced hydrocarbon group, in which unreacted residual groups present on a surface of the polysiloxane network structure have been eliminated or reduced by reaction with at least one modifying silane compound selected from the group consisting of hydrocarbon group-containing monoalkoxysilanes, hydrocarbon group-containing dialkoxysilanes, hydrocarbon group-containing monochlorosilanes, hydrocarbon group-containing dichlorosilanes, and hydrocarbon group-containing trichlorosilanes.

### TECHNICAL FIELD

The present invention relates to techniques of effectively utilizing biogas containing acid gas and methane gas, which is, for example, obtained by biologically treating garbage or the like. More particularly, the present invention relates to an acid gas-containing gas treatment separation membrane for separating acid gas or methane gas contained in biogas, and a method for manufacturing the acid gas-containing gas treatment separation membrane.

### BACKGROUND ART

The biological treatment of garbage or the like is accompanied by production of biogas that is a mixture of acid gas (carbon dioxide, hydrogen sulfide, etc.) and combustible gas (methane gas, etc.). This biogas can be directly combusted and therefore can, for example, be used as fuel in thermal power generation or the like. Recently, to effectively utilize energy, methane gas, which is a combustible component, is extracted from the biogas, and is used as a material for town gas or a source of hydrogen used in fuel cells.

In the background art, among the techniques of separating methane gas from a gas mixture, such as biogas or the like, is a methane concentration device that includes two separation membrane stages, and applies the gas mixture to the separation membrane stages serially to remove gases other than methane gas from the gas mixture in a stepwise fashion and thereby increase the methane gas concentration (see, for example, Patent Document 1). The methane concentration device of Patent Document 1 separates a gas A having a smaller molecular size than that of methane gas from a gas mixture. As the separation membranes, an inorganic porous membrane is employed which has a permeation rate ratio “A/methane” of the gas A to methane of 5 or more and a permeation rate of 1×10⁹ or more (mol·m⁻²·s⁻¹·Pa⁻¹) with respect to the gas A. Patent Document 1 suggests that the use of such a separation membrane can allow for recovery of a gas having a high methane concentration at a high recovery rate.

A gas having a high methane concentration may be obtained from a gas mixture as follows. If carbon dioxide is separated from the gas mixture, the concentration of methane gas in the gas mixture relatively increases, so that a gas having a high methane concentration is obtained. Carbon dioxide may be separated from a gas mixture using a gas separation filter that includes a separation membrane formed from an amorphous oxide having a plurality of pores formed by cyclic siloxanes, where a basic functional group containing nitrogen (N) and silicon (Si) is bonded as a side chain to Si (see, for example, Patent Document 2). Patent Document 2 suggests that such a gas separation filter can allow acid gas, such as carbon dioxide or the like, to efficiently pass through the narrow pores, and therefore, can have high separation performance.

### CITATION LIST

### Patent Literature

Patent Document 1: Japanese Unexamined Patent Application Publication No. 2008-260739

Patent Document 2: Japanese Unexamined Patent Application Publication No. 2000-279773

### SUMMARY OF INVENTION

### Technical Problem

To concentrate methane gas in a gas mixture using a separation membrane, the separation membrane needs to be capable of allowing carbon dioxide contained in the gas mixture to efficiently pass therethrough. In this regard, the methane concentration device of Patent Document 1 employs a separation membrane that separates a gas A having a smaller molecular size than that of methane gas, and the gas A includes carbon dioxide. Patent Document 1 describes an example separation membrane that has a permeation rate ratio “CO₂/CH₄” of carbon dioxide to methane of 3.3-20. However, such a low permeation rate ratio causes a large loss of methane gas. Therefore, as in Patent Document 1, it is necessary to provide two separation membrane stages and additionally a complicated device configuration that recirculates a gas that has previously failed to pass, for example. Otherwise, it would be difficult to sufficiently increase the methane gas concentration to a practical level. Also, if the separation membrane is formed by utilizing the sol-gel reaction of silicon alkoxide as in Patent Document 1, alkoxy groups may remain on the surface of the separation membrane. When gas separation is performed using a separation membrane having residual alkoxy groups, the gas reacts with the residual alkoxy group, so that the molecular structure of the separation membrane may be altered, which may adversely influence the gas separation performance.

The gas separation filter of Patent Document 2 is intended to increase carbon dioxide separation performance by introducing a basic functional group containing nitrogen (N) and silicon (Si) into a surface of a separation membrane. To provide sufficient carbon dioxide separation performance, it is important to form a uniform membrane while introducing a sufficient number of functional groups into the surface of the separation membrane. However, in the separation membrane of Patent Document 2, the number of functional groups that can be introduced is determined based on the molecular structure (the number of reaction sites) of a material for the separation membrane. Therefore, there is a limit on an improvement in the carbon dioxide separation performance only by modifying the separation membrane itself. Also, as the number of functional groups introduced into the separation membrane increases, steric hindrance more easily occurs in the molecular structure, which is likely to adversely influence the formation of a uniform membrane.

With the above problems in mind, the present invention has been made. It is an object of the present invention to provide an acid gas-containing gas treatment separation membrane capable of separating acid gas or methane gas from biogas containing acid gas, such as carbon dioxide or the like, and methane gas, to provide a gas having a high methane concentration, and a method for manufacturing the acid gas-containing gas treatment separation membrane.

### Solution to Problem

To achieve the above object, an acid gas-containing gas treatment separation membrane according to the present invention includes a polysiloxane network structure having an introduced hydrocarbon group, in which unreacted residual groups present on a surface of the polysiloxane network structure have been eliminated or reduced by reaction with at least one modifying silane compound selected from the group consisting of hydrocarbon group-containing monoalkoxysilanes, hydrocarbon group-containing dialkoxysilanes, hydrocarbon group-containing monochlorosilanes, hydrocarbon group-containing dichlorosilanes, and hydrocarbon group-containing trichlorosilanes.

According to the acid gas-containing gas treatment separation membrane thus configured, unreacted residual groups present on a surface of the polysiloxane network structure react with at least one modifying silane compound selected from the group consisting of hydrocarbon group-containing monoalkoxysilanes, hydrocarbon group-containing dialkoxysilanes, hydrocarbon group-containing monochlorosilanes, hydrocarbon group-containing dichlorosilanes, and hydrocarbon group-containing trichlorosilanes (dealcoholization), to form a siloxane linkage. Therefore, unreacted residual groups, which may alter the molecular structure of the separation membrane, can be eliminated or reduced. Therefore, the separation membrane generated after the reaction can have the stable polysiloxane network structure and keep the gas separation performance for a long period of time. The hydrocarbon groups possessed by the polysiloxane network structure inherently have affinity for carbon dioxide or methane gas, and the modifying silane compound for reaction also contains a hydrocarbon group. Therefore, the produced separation membrane contains a large amount of hydrocarbon groups, and therefore, the affinity of the separation membrane for carbon dioxide or methane gas can be synergistically increased. When biogas containing acid gas, such as carbon dioxide, etc., and methane gas is applied to the acid gas-containing gas treatment separation membrane having this configuration, carbon dioxide contained in the biogas is selectively attracted and allowed to pass through the separation membrane. As a result, the methane gas component of the biogas is concentrated, and therefore, a gas having a high methane concentration can be efficiently obtained.

In the acid gas-containing gas treatment separation membrane of the present invention,

the polysiloxane network structure having the introduced hydrocarbon group is preferably a composite polysiloxane network structure obtained by reaction of a tetraalkoxysilane with a hydrocarbon group-containing trialkoxysilane containing the hydrocarbon group.

The acid gas-containing gas treatment separation membrane thus configured is formed from a tetraalkoxysilane and a hydrocarbon group-containing trialkoxysilane, which are caused to react with each other to form a composite polysiloxane network structure. The composite polysiloxane network structure has both a stable structure derived from the tetraalkoxysilane and high affinity for carbon dioxide derived from the hydrocarbon group-containing trialkoxysilane. Therefore, if the composite polysiloxane network structure is utilized in the acid gas-containing gas treatment separation membrane, the methane gas component of biogas can be efficiently concentrated.

In the acid gas-containing gas treatment separation membrane of the present invention,

the tetraalkoxysilane is preferably tetramethoxysilane or tetraethoxysilane (indicated by “A”), and

the hydrocarbon group-containing trialkoxysilane is preferably a trimethoxysilane or triethoxysilane whose Si atom is bonded with an alkyl group having 1-6 carbon atoms or a phenyl group (indicated by “B”).

According to the acid gas-containing gas treatment separation membrane thus configured, the above advantageous combinations of the tetraalkoxysilane (A) and the hydrocarbon group-containing trialkoxysilane (B) are selected, and therefore, a composite polysiloxane network structure having both a stable structure and high affinity for carbon dioxide can be efficiently obtained. The acid gas-containing gas treatment separation membrane employing such a composite polysiloxane network structure can have good carbon dioxide or methane gas separation performance.

In the acid gas-containing gas treatment separation membrane of the present invention,

the mixing ratio (A/B) of the A to the B, expressed in a mole ratio, is preferably 1/9-9/1.

According to the acid gas-containing gas treatment separation membrane thus configured, the mixing ratio of the tetraalkoxysilane (A) to the hydrocarbon group-containing trialkoxysilane (B), expressed in a mole ratio, is set to an appropriate value, i.e., 1/9-9/1. Therefore, the acid gas-containing gas treatment separation membrane can efficiently separate acid gas or methane gas.

In the acid gas-containing gas treatment separation membrane of the present invention,

the hydrocarbon group-containing monoalkoxysilane is preferably a monomethoxysilane or monoethoxysilane whose Si atom is bonded with the same or different hydrocarbon groups, each of which is an alkyl group having 1-6 carbon atoms or a phenyl group, and

the hydrocarbon group-containing dialkoxysilane is preferably a dimethoxysilane or diethoxysilane whose Si atom is bonded with the same or different hydrocarbon groups, each of which is an alkyl group having 1-6 carbon atoms or a phenyl group.

According to the acid gas-containing gas treatment separation membrane thus configured, the above advantageous hydrocarbon group-containing monoalkoxysilanes and hydrocarbon group-containing dialkoxysilanes are selected, and therefore, satisfactorily react with unreacted residual groups present on a surface of the polysiloxane network structure, so that the unreacted residual groups can be reliably eliminated. As a result, a composite polysiloxane network structure having both a stable structure and high affinity for carbon dioxide can be efficiently obtained. The acid gas-containing gas treatment separation membrane employing such a composite polysiloxane network structure can have good carbon dioxide or methane gas separation performance.

In the acid gas-containing gas treatment separation membrane of the present invention,

the hydrocarbon group-containing monochlorosilane is preferably a monochlorosilane whose Si atom is bonded with the same or different hydrocarbon groups, each of which is an alkyl group having 1-6 carbon atoms or a phenyl group,

the hydrocarbon group-containing dichlorosilane is preferably a dichlorosilane whose Si atom is bonded with the same or different hydrocarbon groups, each of which is an alkyl group having 1-6 carbon atoms or a phenyl group, and

the hydrocarbon group-containing trichlorosilane is preferably a trichlorosilane whose Si atom is bonded with a hydrocarbon group which is an alkyl group having 1-6 carbon atoms or a phenyl group.

According to the acid gas-containing gas treatment separation membrane thus configured, the above advantageous hydrocarbon group-containing monochlorosilanes, hydrocarbon group-containing dichlorosilanes, and hydrocarbon group-containing trichlorosilanes are selected, and therefore, satisfactorily react with unreacted residual groups present on a surface of the polysiloxane network structure, so that the unreacted residual groups can be reliably eliminated. As a result, a composite polysiloxane network structure having both a stable structure and high affinity for carbon dioxide can be efficiently obtained. The acid gas-containing gas treatment separation membrane employing such a composite polysiloxane network structure can have good carbon dioxide or methane gas separation performance.

To achieve the above object, a method for manufacturing an acid gas-containing gas treatment separation membrane according to the present invention, includes:

(a) a preparation step of formulating a preparation solution containing a mixture of an acid catalyst, water, and an organic solvent, and a treatment solution containing a mixture of an acid catalyst, an organic solvent, and at least one modifying silane compound selected from the group consisting of hydrocarbon group-containing monoalkoxysilanes, hydrocarbon group-containing dialkoxysilanes, hydrocarbon group-containing monochlorosilanes, hydrocarbon group-containing dichlorosilanes, and hydrocarbon group-containing trichlorosilanes;

(b) a first mixing step of mixing the preparation solution with a tetraalkoxysilane;

(c) a second mixing step of mixing the mixture solution obtained in the first mixing step with a hydrocarbon group-containing trialkoxysilane;

(d) a first application step of applying the mixture solution obtained in the second mixing step to an inorganic porous support member;

(e) a formation step of performing a thermal treatment on the inorganic porous support member after completion of the first application step, to form a polysiloxane network structure having an introduced hydrocarbon group on a surface of the inorganic porous support member;

(f) a second application step of applying the treatment solution to a surface of the polysiloxane network structure; and

(g) a reaction step of performing a thermal treatment on the polysiloxane network structure after completion of the second application step, and causing unreacted residual groups present on a surface of the polysiloxane network structure to react with the modifying silane compound contained in the treatment solution, to eliminate or reduce the unreacted residual groups.

According to the acid gas-containing gas treatment separation membrane manufacturing method thus configured, unreacted residual groups present on a surface of the polysiloxane network structure react with at least one modifying silane compound selected from the group consisting of hydrocarbon group-containing monoalkoxysilanes, hydrocarbon group-containing dialkoxysilanes, hydrocarbon group-containing monochlorosilanes, hydrocarbon group-containing dichlorosilanes, and hydrocarbon group-containing trichlorosilanes (dealcoholization), to form a siloxane linkage. Therefore, unreacted residual groups, which may alter the molecular structure of the separation membrane, can be eliminated or reduced. Therefore, the separation membrane generated after the reaction can have the stable polysiloxane network structure and keep the gas separation performance for a long period of time. The hydrocarbon groups possessed by the polysiloxane network structure inherently have affinity for carbon dioxide or methane gas, and the modifying silane compound for reaction also contains a hydrocarbon group. Therefore, the produced separation membrane contains a large amount of hydrocarbon groups, and therefore, the affinity of the separation membrane for carbon dioxide or methane gas can be synergistically increased.

Also, to form the hydrocarbon group-introduced polysiloxane network structure, a tetraalkoxysilane and a hydrocarbon group-containing trialkoxysilane are used as the material silicon alkoxide. A sol-gel reaction of the tetraalkoxysilane proceeds in the first mixing step, and a sol-gel reaction of the hydrocarbon group-containing trialkoxysilane proceeds in the second mixing step, i.e., a two-step scheme is employed. Therefore, the hydrolysis of the alkoxysilane solution is prevented from proceeding rapidly. As a result, a uniform and dense acid gas-containing gas treatment separation membrane having good carbon dioxide or methane gas separation performance can be formed.

In the acid gas-containing gas treatment separation membrane manufacturing method of the present invention,

the preparation step preferably includes adding a metal salt having affinity for acid gas to the preparation solution.

According to the acid gas-containing gas treatment separation membrane manufacturing method thus configured, the hydrocarbon groups possessed by the polysiloxane network structure inherently have affinity for carbon dioxide or methane gas. Therefore, if, in the preparation step, a metal salt having affinity for acid gas is added to the preparation solution, the polysiloxane network structure is doped with the metal salt having affinity for acid gas (including carbon dioxide), and therefore, the affinity of the separation membrane for carbon dioxide can be synergistically increased. When biogas containing acid gas, such as carbon dioxide, etc., and methane gas is applied to the produced separation membrane, carbon dioxide contained in the biogas is selectively attracted and allowed to pass through the separation membrane. As a result, the methane gas component of the biogas is concentrated, and therefore, a gas having a high methane concentration can be efficiently obtained.

In the acid gas-containing gas treatment separation membrane manufacturing method of the present invention,

in the first mixing step, the tetraalkoxysilane is preferably tetramethoxysilane or tetraethoxysilane (indicated by “A”), and

in the second mixing step, the hydrocarbon group-containing trialkoxysilane is preferably a trimethoxysilane or triethoxysilane whose Si atom is bonded with an alkyl group having 1-6 carbon atoms or a phenyl group (indicated by “B”).

According to the acid gas-containing gas treatment separation membrane manufacturing method thus configured, the above advantageous combinations of the tetraalkoxysilane (A) and the hydrocarbon group-containing trialkoxysilane (B) are selected, and therefore, a composite polysiloxane network structure having both a stable structure and high affinity for carbon dioxide can be efficiently obtained. The acid gas-containing gas treatment separation membrane employing such a composite polysiloxane network structure can have good carbon dioxide or methane gas separation performance.

In the acid gas-containing gas treatment separation membrane manufacturing method of the present invention,

the mixing ratio (A/B) of the A to the B, expressed in a mole ratio, is preferably 1/9-9/1.

According to the acid gas-containing gas treatment separation membrane manufacturing method thus configured, the mixing ratio of the tetraalkoxysilane (A) to the hydrocarbon group-containing trialkoxysilane (B), expressed in a mole ratio, is set to an appropriate value, i.e., 1/9-9/1. Therefore, the acid gas-containing gas treatment separation membrane can efficiently separate acid gas or methane gas.

### DESCRIPTION OF EMBODIMENTS

Embodiments of an acid gas-containing gas treatment separation membrane of the present invention and a method for manufacturing the acid gas-containing gas treatment separation membrane will now be described. Note that the present invention is not intended to be limited to configurations described below.

<Acid Gas-Containing Gas Treatment Separation Membrane>

The acid gas-containing gas treatment separation membrane of the present invention is provided for treating biogas that is, for example, obtained by biologically treating garbage or the like. The biogas contains a gas mixture of acid gas (containing carbon dioxide as a main component, and other components, such as hydrogen sulfide and the like) and methane gas. As used herein, the biogas refers to a gas mixture of carbon dioxide and methane gas. Therefore, in the description that follows, for the sake of convenience, the acid gas is assumed to be carbon dioxide as an example, and the acid gas-containing gas treatment separation membrane is assumed to be a carbon dioxide separation membrane that selectively attracts carbon dioxide. Note that the acid gas-containing gas treatment separation membrane of the present invention may be configured as a methane gas separation membrane that selectively attracts methane gas, or alternatively, as a carbon dioxide/methane gas separation membrane that can simultaneously separate carbon dioxide and methane gas. The acid gas-containing gas treatment separation membrane may also be hereinafter simply referred to a “separation membrane.”

The acid gas-containing gas treatment separation membrane is configured by causing a polysiloxane network structure having an introduced hydrocarbon group to react with a modifying silane compound containing a hydrocarbon group. As the modifying silane compound, for example, used is at least one selected from the group consisting of hydrocarbon group-containing monoalkoxysilanes, hydrocarbon group-containing dialkoxysilanes, hydrocarbon group-containing monochlorosilanes, hydrocarbon group-containing dichlorosilanes, and hydrocarbon group-containing trichlorosilanes. Also, the polysiloxane network structure and the modifying silane compound may have the same or different hydrocarbon groups. The polysiloxane network structure having an introduced hydrocarbon group is obtained by causing a tetraalkoxysilane to react with a hydrocarbon group-containing trialkoxysilane.

Tetraalkoxysilanes are a tetrafunctional alkoxysilane represented by the following formula (1).

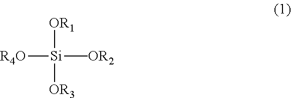

where R₁ to R₄ represent the same or different alkyl groups having one or two carbon atoms.

A preferable tetraalkoxysilane is tetramethoxysilane (TMOS), in which all R₁ to R₄ are a methyl group in Formula (1), or tetraethoxysilane (TEOS), in which all R₁ to R₄ are an ethyl group in Formula (1).

Hydrocarbon group-containing trialkoxysilanes are a trifunctional alkoxysilane represented by the following formula (2).

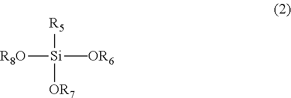

where R₅ represents an alkyl group having 1-6 carbon atoms or a phenyl group, and R₆ to R₈ represent the same or different alkyl groups having one or two carbon atoms.

A preferable hydrocarbon group-containing trialkoxysilane is a trimethoxysilane, in which all R₆ to R₈ are a methyl group, or a triethoxysilane, in which all R₆ to R₈ are an ethyl group, with their Si atoms being bonded with an alkyl group having 1-6 carbon atoms or a phenyl group, in Formula (2). Examples of the preferable hydrocarbon group-containing trialkoxysilane include methyltrimethoxysilane, methyltriethoxysilane, ethyltrimethoxysilane, ethyltriethoxysilane, propyltrimethoxysilane, propyltriethoxysilane, butyltrimethoxysilane, butyltriethoxysilane, pentyltrimethoxysilane, pentyltriethoxysilane, hexyltrimethoxysilane, hexyltriethoxysilane, phenyltrimethoxysilane, and phenyltriethoxysilane.

If a tetrafunctional alkoxysilane of Formula (1) and a trifunctional alkoxysilane of Formula (2) are caused to react with each other, a composite polysiloxane network structure represented by the following formula (3) is obtained, for example.

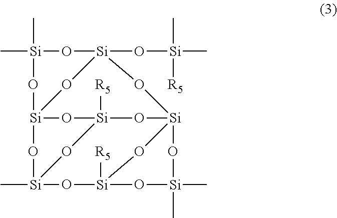

where R₅ represents an alkyl group having 1-6 carbon atoms or a phenyl group.

In the composite polysiloxane network structure of Formula (3), the hydrocarbon group R₅ is present in the polysiloxane network structure, which forms a kind of organic-inorganic composite material.

Here, the present inventors have studied characteristics of the trifunctional alkoxysilane of Formula (2) to discover that methyltrimethoxysilane or methyltriethoxysilane (the hydrocarbon group has one carbon atom) mainly has affinity for carbon dioxide, and trimethoxysilanes or triethoxysilanes whose Si atom is bonded with an alkyl group having 2-6 carbon atoms or a phenyl group (the hydrocarbon group has 2-6 carbon atoms) mainly have affinity for methane gas. In addition, when the tetrafunctional alkoxysilane of Formula (1) and the trifunctional alkoxysilane of Formula (2) are caused to react with each other to synthesize the composite polysiloxane network structure of Formula (3), it is important to optimize the mixing ratio of the tetrafunctional alkoxysilane (indicated by “A”) to the trifunctional alkoxysilane (indicated by “B”) in order to form a separation membrane having good carbon dioxide or methane gas separation performance. The optimum mixing ratio A/B found by the present inventors, which is expressed in a mole ratio, is 1/9-9/1, preferably 3/7-7/3, and more preferably 4/6-6/4. Such a mixing ratio allows for efficient production of a composite polysiloxane network structure which has both stable structure and high carbon dioxide affinity. Note that the amount of methyltrimethoxysilane or methyltriethoxysilane contained in the trifunctional alkoxysilane may be increased in order to increase the affinity of the trifunctional alkoxysilane used as “B” for carbon dioxide. The amount of a trimethoxysilane or triethoxysilane whose Si atom is bonded with an alkyl group having 2-6 carbon atoms or a phenyl group, that is contained in the trifunctional alkoxysilane, may be increased in order to increase the affinity for methane gas.

Incidentally, an alkoxy group and a hydroxy group may remain on the surface of the composite polysiloxane network structure of Formula (3) (these remaining groups are referred to as “unreacted residual groups”). For example, a polysiloxane network structure represented by the following formula (3′) may be formed.

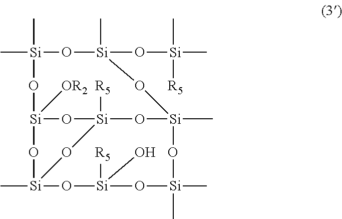

where R₂ is an alkyl group having one or two carbon atoms, and R₅ is an alkyl group having 1-6 carbon atoms or a phenyl group.

In the polysiloxane network structure of Formula (3′), the material tetraalkoxysilane or hydrocarbon group-containing trialkoxysilane does not completely react, and therefore, a portion of the alkoxy groups remains as unreacted residual groups. Also, some alkoxy groups do not sufficiently undergo hydrolysis reaction, and therefore, remain as unreacted residual groups in the form of a hydroxy group. When such unreacted residual groups are present on the surface of the polysiloxane network structure, the polysiloxane network structure is altered, which may adversely influence the gas separation performance. Therefore, in the present invention, in order to eliminate or reduce the unreacted residual groups, the above modifying silane compound having a hydrocarbon group is caused to react with the polysiloxane network structure.

Hydrocarbon group-containing monoalkoxysilanes, which are a modifying silane compound, are a monomethoxysilane or monoethoxysilane whose Si atom is bonded with the same or different hydrocarbon groups, each of which is an alkyl group having 1-6 carbon atoms or a phenyl group, and that is represented by the following formula (4).

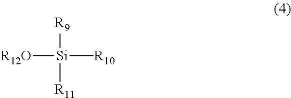

where R₉ to R₁₁ represent the same or different hydrocarbon groups, each of which is an alkyl group having 1-6 carbon atoms or a phenyl group, and R₁₂ represents an alkyl group having one or two carbon atoms.

Hydrocarbon group-containing dialkoxysilanes, which are a modifying silane compound, are a dimethoxysilane or diethoxysilane whose Si atom is bonded with the same or different hydrocarbon groups, each of which is an alkyl group having 1-6 carbon atoms or a phenyl group, and that is represented by the following formula (5).

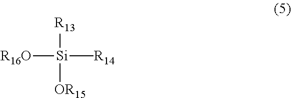

where R₁₃ and R₁₄ represent the same or different hydrocarbon groups, each of which is an alkyl group having 1-6 carbon atoms or a phenyl group, and R₁₅ and R₁₆ represent an alkyl group having one or two carbon atoms.

A preferable hydrocarbon group-containing monoalkoxysilane is trimethylmethoxysilane. A preferable hydrocarbon group-containing dialkoxysilane is a dimethyldiethoxysilane. When trimethylmethoxysilane and dimethyldiethoxysilane react with unreacted residual groups on the surface of the polysiloxane network structure, no further reaction will occur, so that the polysiloxane network structure becomes stable while the unreacted residual groups remain eliminated or reduced.

Hydrocarbon group-containing monochlorosilanes, which are a modifying silane compound, are a monochlorosilane whose Si atom is bonded with the same or different hydrocarbon groups, each of which is an alkyl group having 1-6 carbon atoms or a phenyl group, and that is represented by the following formula (6).

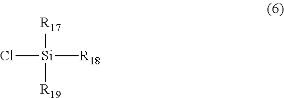

where R₁₇ to R₁₉ represent the same or different hydrocarbon groups, each of which is an alkyl group having 1-6 carbon atoms or a phenyl group.

Hydrocarbon group-containing dichlorosilanes, which are a modifying silane compound, are a dichlorosilane whose Si atom is bonded with the same or different hydrocarbon groups, each of which is an alkyl group having 1-6 carbon atoms or a phenyl group, and that is represented by the following formula (7).

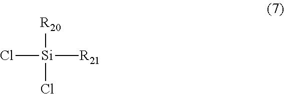

where R₂₀ and R₂₁ represent the same or different hydrocarbon groups, each of which is an alkyl group having 1-6 carbon atoms or a phenyl group.

Hydrocarbon group-containing trichlorosilanes, which are a modifying silane compound, are a trichlorosilane whose Si atom is bonded with an alkyl group having 1-6 carbon atoms or a phenyl group, and that is represented by the following formula (8).

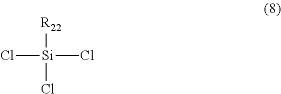

where R₂₂ represents an alkyl group having 1-6 carbon atoms or a phenyl group.

A preferable hydrocarbon group-containing monochlorosilane is trimethylchlorosilane. A preferable hydrocarbon group-containing dichlorosilane is dimethyldichlorosilane. A preferable hydrocarbon group-containing trichlorosilane is methyltrichlorosilane. When trimethylchlorosilane, dimethyldichlorosilane, and methyltrichlorosilane react with unreacted residual groups on the surface of the polysiloxane network structure, no further reaction will occur, so that the polysiloxane network structure becomes stable while the unreacted residual groups remain eliminated or reduced. Note that hydrocarbon group-containing monochlorosilanes, hydrocarbon group-containing dichlorosilanes, and hydrocarbon group-containing trichlorosilanes mainly react with hydroxy groups of unreacted residual groups to form silanol bonds.

As an example, the polysiloxane network structure having unreacted residual groups of Formula (3′) may be modified using the hydrocarbon group-containing monoalkoxysilane of Formula (4) and the hydrocarbon group-containing dialkoxysilane of Formula (5) so that the unreacted residual groups are eliminated from the surface of the polysiloxane network structure. The resultant polysiloxane network structure is represented by the following formula (9).

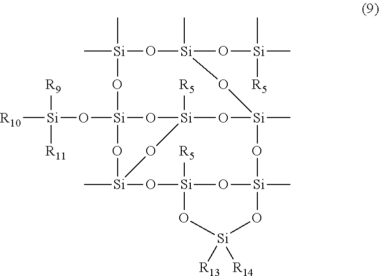

where R₅, R₉ to R₁₁, R₁₃, and R₁₄ represent the same or different hydrocarbon groups, each of which is an alkyl group having 1-6 carbon atoms or a phenyl group.

The modifying silane compound which is used to eliminate or reduce unreacted residual groups contains a hydrocarbon group(s), and therefore, the produced separation membrane has a large hydrocarbon group content, which synergistically increases the affinity for carbon dioxide or methane gas by the synergistic effect with hydrocarbon groups possessed by the polysiloxane network structure. As a result, a composite polysiloxane network structure having both stable structure and high affinity for carbon dioxide can be efficiently obtained. An acid gas-containing gas treatment separation membrane employing such a composite polysiloxane network structure may have good carbon dioxide or methane gas separation performance.

<Method for Manufacturing Acid Gas-Containing Gas Treatment Separation Membrane>

The acid gas-containing gas treatment separation membrane of the present invention is manufactured by performing the following steps (a)-(g). Each step will now be described in detail.

(a) Preparation Step

A preparation step includes formulating a preparation solution which is a mixture of an acid catalyst, water, and an organic solvent. The preparation solution is used in a “first mixing step” following the preparation step. The amounts of the acid catalyst, water, and organic solvent in the mixture are preferably adjusted to 0.005-0.1 mol, 0.5-10 mol, and 5-60 mol, respectively, with respect to a total of 1 mol of a modifying silane compound described below. If the amount of the acid catalyst in the mixture is less than 0.005 mol, the hydrolysis rate is low, and therefore, it takes a long time to manufacture a separation membrane. If the amount of the acid catalyst in the mixture is more than 0.1 mol, the hydrolysis rate is excessively high, and therefore, it is difficult to obtain a uniform separation membrane. If the amount of water in the mixture is less than 0.5 mol, the hydrolysis rate is low, and therefore, a sol-gel reaction described below does not sufficiently proceed. If the amount of water in the mixture is more than 10 mol, the hydrolysis rate is excessively high, and therefore, the pore diameter increases, so that it is difficult to obtain a dense separation membrane. If the amount of the organic solvent in the mixture is less than 5 mol, the concentration of a mixture solution containing a tetraalkoxysilane and a hydrocarbon group-containing trialkoxysilane described below is high, and therefore, it is difficult to obtain a dense and uniform separation membrane. If the amount of the organic solvent in the mixture is more than 60 mol, the concentration of a mixture solution containing a tetraalkoxysilane and a hydrocarbon group-containing trialkoxysilane described below is low, and therefore, the number of times of coating with the mixture solution (the number of steps) increases, resulting in a reduction in production efficiency. Examples of the acid catalyst include nitric acid, hydrochloric acid, sulfuric acid, and the like. Of them, nitric acid or hydrochloric acid is preferable. Examples of the organic solvent include methanol, ethanol, propanol, butanol, benzene, toluene, and the like. Of them, methanol or ethanol is preferable.

It is also preferable to add a metal salt having affinity for acid gas to the preparation solution. The hydrocarbon groups possessed by the polysiloxane network structure inherently have affinity for carbon dioxide or methane gas. Therefore, if, in the preparation step, a metal salt having affinity for acid gas is added to the preparation solution, the polysiloxane network structure is doped with the metal salt having affinity for acid gas (including carbon dioxide), and therefore, the affinity of the separation membrane for carbon dioxide can be synergistically increased. The metal salt having affinity for acid gas is, for example, an acetate, nitrate, carbonate, borate, or phosphate of at least one metal selected from the group consisting of Li, Na, K, Mg, Ca, Ni, Fe, and Al. Of them, a nitrate (e.g., magnesium nitrate) is preferable.

The preparation step further includes formulating a treatment solution which is a mixture of an acid catalyst, an organic solvent, and a modifying silane compound. The treatment solution is used in a “second application step” described below. The amounts of the acid catalyst, organic solvent, and modifying silane compound in the mixture are preferably adjusted to 0.001-0.1 mol, 0.1-10 mol, and 0.1-5 mol, respectively. If the amount of the acid catalyst in the mixture is less than 0.001 mol, the hydrolysis rate is low, and therefore, it takes a long time to manufacture a separation membrane. If the amount of the acid catalyst in the mixture is more than 0.1 mol, the hydrolysis rate is excessively high, and therefore, it is difficult to obtain a uniform separation membrane. If the amount of the organic solvent in the mixture is less than 0.1 mol, a mixture solution containing a tetraalkoxysilane and a hydrocarbon group-containing trialkoxysilane described below has a high concentration, and therefore, it is difficult to obtain a dense and uniform separation membrane. If the amount of the organic solvent in the mixture is more than 10 mol, a mixture solution containing a tetraalkoxysilane and a hydrocarbon group-containing trialkoxysilane described below has a low concentration, and therefore, the number of times of coating with the mixture solution (the number of steps) increases, resulting in a reduction in production efficiency. If the amount of the modifying silane compound in the mixture is less than 0.1 mol, it is difficult to eliminate unreacted residual groups. If the amount of the modifying silane compound in the mixture is more than 5 mol, an excessive amount of the modifying silane compound is supplied, and therefore, it may be conversely difficult for the modifying silane compound to react with unreacted residual groups. The acid catalyst and the organic solvent may be similar to those used in the preparation solution. The organic solvent used in formulating the treatment solution is preferably toluene. In the “second application step” described below, the treatment solution is applied to the polysiloxane network structure having an introduced hydrocarbon group. In this case, if toluene is used, the pore size of the separation membrane is prevented from increasing due to the modification treatment, because the polysiloxane network structure has a low solubility in toluene. The modifying silane compound used may be those described in the above section “Acid Gas-containing Gas Treatment Separation Membrane.”

(b) First Mixing Step

A first mixing step includes mixing the preparation solution formulated in the preparation step with a tetraalkoxysilane. At this time, in the mixture solution, a sol-gel reaction begins in which the tetraalkoxysilane repeatedly undergoes hydrolysis and polycondensation. The tetraalkoxysilane used may be those described above in the section “Acidic Gas-containing Gas Treatment Separation Membrane.” For example, if tetraethoxysilane (TEOS) is used as an example of the tetraalkoxysilane, the sol-gel reaction may proceed according to the following scheme (Scheme 1). Note that Scheme 1 is a model of the process of the sol-gel reaction, and may not necessarily exactly correspond to the actual molecular structure.

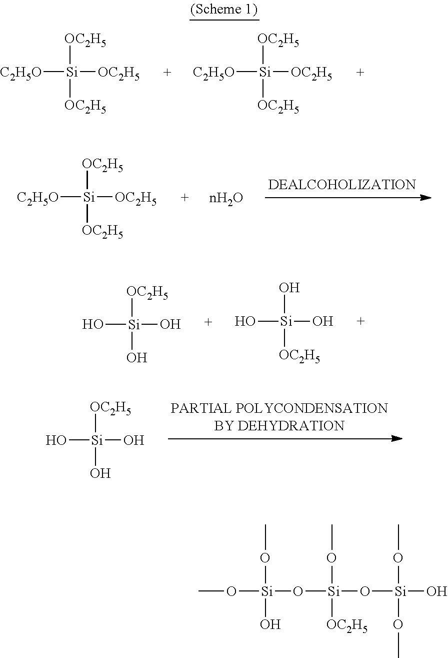

According to Scheme 1, a portion of the ethoxy groups of tetraethoxysilane is initially hydrolyzed and dealcoholized to produce a silanol group(s). A portion of the ethoxy groups of tetraethoxysilane may not be hydrolyzed, and may remain unchanged. Next, a portion of the silanol groups is associated with a neighboring silanol group(s) to undergo polycondensation due to dehydration. As a result, a siloxane backbone with remaining silanol or ethoxy groups is formed. The above hydrolysis reaction and dehydration polycondensation reaction substantially uniformly proceed in the mixture solution system, and therefore, silanol or ethoxy groups are substantially uniformly distributed in the siloxane backbone. In this stage, the molecular weight of the siloxane is not significantly large, i.e., the siloxane is an oligomer rather than a polymer. Therefore, the silanol group-containing or ethoxy group-containing siloxane oligomer is dissolved in the mixture solution containing an organic solvent.

(c) Second Mixing Step

A second mixing step includes mixing the mixture solution containing the siloxane oligomer obtained in the first mixing step with a hydrocarbon group-containing trialkoxysilane. As a result, a reaction of the siloxane oligomer with the hydrocarbon group-containing trialkoxysilane begins. In the present invention, as the material silicon alkoxide, a tetraalkoxysilane and a hydrocarbon group-containing trialkoxysilane are used. A sol-gel reaction of the tetraalkoxysilane proceeds in the first mixing step, and a sol-gel reaction of the hydrocarbon group-containing trialkoxysilane proceeds in the second mixing step, i.e., a two-step scheme is employed. Therefore, the hydrolysis of the alkoxysilane solution is prevented from proceeding rapidly. As a result, a uniform and dense acid gas-containing gas treatment separation membrane having good carbon dioxide or methane gas separation performance can be formed. Incidentally, in conventional techniques in which the sol-gel reactions are conducted in one step, the sol-gel reaction of the hydrocarbon group-containing trialkoxysilane proceed faster than the sol-gel reaction of the tetraalkoxysilane, and therefore, the acid gas-containing gas treatment separation membrane eventually obtained is unlikely to have a uniform and dense structure.

The hydrocarbon group-containing trialkoxysilane used may be those described in the above section “Acid Gas-containing Gas Treatment Separation Membrane.” For example, when methyltriethoxysilane is used as an example of the hydrocarbon group-containing trialkoxysilane, the reaction may proceed according to the following scheme (Scheme 2). Note that Scheme 2 is a model of the process of the reaction, and may not necessarily exactly correspond to the actual molecular structure.

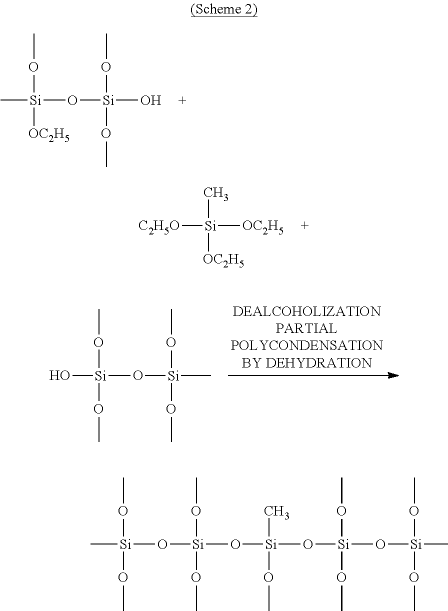

According to Scheme 2, a silanol or ethoxy group of a siloxane oligomer, and an ethoxy group of methyltriethoxysilane, react with each other to undergo dealcoholization, resulting in a polysiloxane. Here, silanol or ethoxy groups of a siloxane oligomer are substantially uniformly distributed in the siloxane backbone as described above. Therefore, the reaction (dealcoholization) of silanol or ethoxy groups of a siloxane oligomer with ethoxy groups of methyltriethoxysilane, that proceeds in the second mixing step, may substantially uniformly proceed. As a result, a siloxane linkage derived from methyltriethoxysilane is substantially uniformly generated in the generated polysiloxane, and therefore, an ethyl group derived from methyltriethoxysilane is also substantially uniformly present in the polysiloxane. In this stage, the polysiloxane has a fairly large molecular weight, and the mixture solution after the second mixing step is a suspension in which the polysiloxane network structure is dispersed.

(d) First Application Step

An application step includes applying the mixture solution (a suspension of the polysiloxane network structure) obtained in the second mixing step to an inorganic porous support member. Examples of a material for the inorganic porous support member include silica-based ceramics, silica-based glass, alumina-based ceramics, stainless steel, titanium, silver, and the like. The inorganic porous support member is assumed to include an inlet portion through which gas flows in, and an outlet portion through which gas flows out. For example, the gas inlet portion is an opening provided in the inorganic porous support member, and the gas outlet portion is an external surface of the inorganic porous support member. The external surface has a large number of pores, and therefore, allows gas to flow out through the entire external surface. The inorganic porous support member may, for example, have a cylindrical structure, pipe-like structure, spiral structure, or the like in which a gas flow path is provided. The inorganic porous support member may be formed by preparing a solid plate object or bulk object formed from an inorganic porous material and then hollowing out a portion of the object to form a gas flow path. The inorganic porous support member preferably has a pore diameter of about 0.01-100 μm. If the pore diameter of the inorganic porous support member is relatively large (e.g., 0.05 μm or more), an intermediate layer is preferably provided on a surface of the inorganic porous support member. If the mixture solution is directly applied to a surface of the inorganic porous support member having a relatively large pore diameter, the mixture solution may excessively permeate the pores without remaining on the surface, and therefore, it is difficult to form a film or layer. Therefore, if an intermediate layer is provided on the surface of the inorganic porous support member, the entrance of the pore is narrowed by the intermediate layer, and therefore, it is easier to apply the mixture solution. Examples of a material for the intermediate layer include α-alumina, γ-alumina, silica, silicalite, and the like.

Examples of a technique of applying the mixture solution to the inorganic porous support member include dipping, spraying, spinning, and the like. Of them, dipping is preferable because the mixture solution can be uniformly and easily applied to the surface of the inorganic porous support member. A specific procedure of dipping will be described.

Initially, the inorganic porous support member is immersed in the mixture solution obtained in the second mixing step. The immersion time is preferably 5 sec to 10 min in order to allow the mixture solution to sufficiently permeate the pores of the inorganic porous support member. If the immersion time is shorter than 5 sec, a sufficient thickness is not obtained. If the immersion time exceeds 10 min, an excessively large thickness is obtained. Next, the inorganic porous support member is pulled out of the mixture solution. A speed at which the inorganic porous support member is pulled out (referred to as a “pulling speed”) is preferably 0.1-2 mm/sec. If the pulling speed is slower than 0.1 mm/sec, an excessively large thickness is obtained. If the pulling speed is faster than 2 mm/sec, a sufficient thickness is not obtained. Next, the inorganic porous support member pulled out is dried. The drying is preferably performed under conditions that 15-40° C. and 0.5-3 h. If the drying time is less than 0.5 h, the inorganic porous support member is not sufficiently dried. If the drying time exceeds 3 h, the dried state remains almost unchanged after three hours of the drying. After the end of the drying, the inorganic porous support member with the polysiloxane network structure adhering to the surface (including inner surfaces of pores) is obtained. Note that, by performing the above series of steps, i.e., the immersion, pulling-out, and drying steps, on the inorganic porous support member a plurality of times, the amount of the polysiloxane network structure adhering to the inorganic porous support member can be increased. Also, by repeatedly performing the series of steps, the mixture solution can be uniformly applied to the inorganic porous support member, and therefore, the performance of the acid gas-containing gas treatment separation membrane eventually obtained can be improved.

(e) Formation Step

A formation step includes performing a thermal treatment on the inorganic porous support member after the first application step to form a hydrocarbon group-introduced polysiloxane network structure on the surface of the inorganic porous support member. The thermal treatment is performed, for example, using a heating means, such as a baking device or the like. A specific procedure for the thermal treatment will be described.

Initially, the temperature of the inorganic porous support member is increased until it reaches a baking temperature described below. The temperature increasing time is preferably 1-24 h. If the temperature increasing time is shorter than 1 h, it is difficult to obtain a uniform membrane due to the sharp change in temperature. If the temperature increasing time is longer than 24 h, the membrane is likely to deteriorate due to the long-time heating. After the end of the temperature increase, baking is performed for a predetermined period of time. The baking temperature is preferably 30-300° C., more preferably 50-200° C. If the baking temperature is lower than 30° C., the baking is not sufficient, so that a dense membrane is not obtained. If the baking temperature is higher than 300° C., the membrane is likely to deteriorate due to the high-temperature heating. The baking time is preferably 0.5-6 h. If the baking time is shorter than 0.5 h, the baking is not sufficient, so that a dense membrane is not obtained. If the baking time is longer than 6 h, the membrane is likely to deteriorate due to the long-time heating. After the end of the baking, the inorganic porous support member is cooled to room temperature. The cooling time is preferably 5-10 h. If the cooling time is shorter than 5 h, the membrane is likely to be broken or come off due to the sharp change in temperature. If the cooling time is longer than 10 h, the membrane is likely to deteriorate. The inorganic porous support member after the cooling has a separation membrane formed on the surface (including inner surfaces of pores) thereof. Note that, after the “formation step,” the process may return to the above “application step.” If the application step and the formation step are repeated one or more times, a denser separation membrane having more uniform membrane quality can be formed on the surface of the inorganic porous support member.

(f) Second Application Step

A second application step includes applying a treatment solution containing a modifying silane compound to a surface of the polysiloxane network structure formed by the formation step. The treatment solution may be applied using a technique similar to that of the first application step.

(g) Reaction Step

A reaction step includes performing a thermal treatment on the inorganic porous support member (polysiloxane network structure) after the second application step, to cause unreacted residual groups present on the surface of the polysiloxane network structure to react with the modifying silane compound contained in the treatment solution. The thermal treatment in the reaction step may be performed under conditions similar to those of the formation step. When the thermal treatment is performed on the inorganic porous support member, dealcoholization or removal of hydrochloric acid occurs between the unreacted residual group and the modifying silane compound, and therefore, the unreacted residual groups on the surface of the polysiloxane network structure gradually decrease, and can be eventually eliminated.

By performing the above steps (a)-(g), the acid gas-containing gas treatment separation membrane of the present invention is manufactured. The separation membrane has a gas attraction layer which has a site (methyl group) attracting a specific gas (carbon dioxide in this embodiment) on the surface and pores of the inorganic porous support member as a base. The gas attraction layer may be formed on the surface of the inorganic porous support member with an intermediate layer being interposed therebetween. When biogas containing carbon dioxide and methane gas is applied to the separation membrane, the gas attraction layer selectively attracts and allows carbon dioxide to pass through the pores. Therefore, the methane gas component of the biogas is concentrated, and therefore, a gas having a high methane concentration can be efficiently obtained. The concentrated methane gas can be used as a material for town gas, and a source for hydrogen used for fuel cells.

### EXAMPLES

Examples of the acid gas-containing gas treatment separation membrane of the present invention will now be described. As the separation membrane, five carbon dioxide separation membranes were produced according to the “Method for Manufacturing Acid Gas-containing Gas Treatment Separation Membrane” described in the above embodiment. For comparison, a carbon dioxide separation membrane was produced using materials used in the examples excluding the hydrocarbon group-containing trialkoxysilane (Comparative Example 1). Materials and their amounts used in Examples 1-5 and Comparative Example 1 are shown in Table 1.

TABLE 1

| | | | | | | | | | | | | Comparative | |
|---|---|---|---|---|---|---|---|---|---|---|---|---|---|
| | | Examples | | | | | | | | | | example | |
| | | 1 | | 2 | | 3 | | 4 | | 5 | | 1 | |
| | | mol | g | mol | g | mol | g | mol | g | mol | g | mol | g |
| Alkoxide | Tetraethoxysilane | 0.6 | 6.48 | 0.6 | 6.48 | 0.9 | 9.36 | 0.4 | 4.35 | 0.4 | 4.35 | 1.0 | 10.60 |
| solution for | Methyltriethoxysilane | 0.4 | 3.70 | 0.4 | 3.70 | 0.1 | 0.89 | 0.6 | 5.59 | 0.6 | 5.59 | — | — |
| forming | Magnesium nitrate | 0.01 | 0.13 | 0.01 | 0.13 | 0.15 | 1.92 | — | — | — | — | 0.05 | 0.65 |
| separation | hexahydrate | | | | | | | | | | | | |
| membrane | Water | 2 | 1.87 | 2 | 1.87 | 2 | 1.80 | 2 | 1.88 | 2 | 1.88 | 2 | 1.83 |
| | Nitric acid | 0.01 | 0.13 | 0.01 | 0.13 | 0.01 | 0.03 | 0.01 | 0.03 | 0.01 | 0.03 | 0.01 | 0.03 |
| | Ethanol | 20 | 47.79 | 20 | 47.79 | 20 | 46.00 | 20 | 48.14 | 20 | 48.14 | 20 | 46.88 |
| | Total | | 60 | | 60 | | 60 | | 60 | | 60 | | 60 |
| Solution for | Trimethylmethoxysilane | 1 | 3.21 | — | — | 1 | 3.21 | 2 | 6.08 | — | — | 1 | 3.21 |
| modification | Dimethyldiethoxysilane | — | — | — | — | — | — | — | — | 1 | 8.31 | — | — |
| treatment | Trimethylchlorosilane | — | — | 1 | 3.33 | — | — | — | — | — | — | — | — |
| | Nitric acid | 0.05 | 0.10 | 0.05 | 0.10 | 0.05 | 0.10 | 0.10 | 0.18 | 0.01 | 0.04 | 0.05 | 0.10 |
| | Toluene | 20 | 56.70 | 20 | 56.57 | 20 | 56.70 | 20 | 53.74 | — | — | 20 | 56.70 |
| | Ethanol | | | | | | | | | 20 | 51.65 | | |
| | Total | | 60 | | 60 | | 60 | | 60 | | 60 | | 60 |

The materials used are the following products or reagents.

[Alkoxide Solution for Forming Separation Membrane]
Tetraethoxysilane: Shin-Etsu Silicone LS-2430, manufactured by Shin-Etsu Chemical Co., Ltd.
Methyltriethoxysilane: Shin-Etsu Silicone LS-1890, manufactured by Shin-Etsu Chemical Co., Ltd.
Nitric acid: super special grade reagent (143-01326) 69.5%, manufactured by Wako Pure Chemical Industries, Ltd.
Ethanol: super special grade reagent (057-00456) 99.5%, manufactured by Wako Pure Chemical Industries, Ltd.
Magnesium nitrate hexahydrate: M5296-500G 98.0%, manufactured by Aldrich

[Modification Treatment Solution]
Trimethylmethoxysilane: Shin-Etsu Silicone LS-260, manufactured by Shin-Etsu Chemical Co., Ltd.
Dimethyldiethoxysilane: Shin-Etsu Silicone LS-1370, manufactured by Shin-Etsu Chemical Co., Ltd.
Trimethylchlorosilane: Shin-Etsu Silicone LS-510, manufactured by Shin-Etsu Chemical Co., Ltd.
Nitric acid: super special grade reagent (143-01326) 69.5%, manufactured by Wako Pure Chemical Industries, Ltd.
Toluene: super special grade reagent (200-01863) 99.5%, manufactured by Wako Pure Chemical Industries, Ltd.
Ethanol: super special grade reagent (057-00456) 99.5%, manufactured by Wako Pure Chemical Industries, Ltd.

### Example 1

Nitric acid, water, and ethanol were mixed according to materials and their amounts described in Table 1, followed by stirring for about 30 min, to formulate a preparation solution. Tetraethoxysilane was added to the preparation solution, followed by stirring for about 1 h. Next, methyltriethoxysilane was added to the preparation solution, followed by stirring for about 2.5 h. Moreover, magnesium nitrate hexahydrate was added to the preparation solution, followed by stirring for about 2 h. As a result, a separation membrane-forming alkoxide solution (mixture solution) was formulated.

Also, in addition to the separation membrane-forming alkoxide solution, a modification treatment solution (treatment solution) was formulated as follows: nitric acid and toluene were mixed, followed by stirring for about 2 h; and next, trimethylmethoxysilane was added as a modifying silane compound to the solution, followed by stirring for about 2 h.

Next, a pipe-like object of an alumina-based ceramic was prepared as an inorganic porous support member. The separation membrane-forming alkoxide solution was applied to a surface of the pipe-like object by dipping. In the dipping step, the pulling speed was 1 mm/s, and after being pulled out, the pipe-like object was dried at room temperature for 1 h. The application and drying of the separation membrane-forming alkoxide solution were performed two times, followed by a thermal treatment in a baking device. The thermal treatment was performed under the following conditions: the temperature was increased from room temperature (25° C.) to 150° C. in 5 h; the temperature was maintained at 150° C. for 2 h; and the temperature was decreased to 25° C. in 5 h. The thermal treatment was performed five times to form a separation membrane of the polysiloxane network structure on a surface of the pipe-like object of the alumina-based ceramic.

Next, the modification treatment solution was applied to a surface of the pipe-like object of the alumina-based ceramic on which the separation membrane had been formed, followed by drying at room temperature for 1 h. The application and drying of the modification treatment solution were performed two times, followed by a thermal treatment in a baking device, to modify the polysiloxane network structure. The thermal treatment was performed under conditions similar to those for the application and drying of the above separation membrane-forming alkoxide solution. The modification treatment caused unreacted residual groups present on the surface of the polysiloxane network structure to react with trimethylmethoxysilane contained in the modification treatment solution. Thus, the production of an acid gas-containing gas treatment separation membrane whose unreacted residual groups are eliminated or reduced was completed.

### Example 2

A preparation solution and a separation membrane-forming alkoxide solution (mixture solution) were formulated by respective procedures similar to those of Example 1, according to materials and their amounts described in Table 1.

A modification treatment solution (treatment solution) was formulated by a procedure similar to that of Example 1, except for the use of trimethylchlorosilane as a modifying silane compound.

A separation membrane having the polysiloxane network structure was formed on a surface of a pipe-like object of an alumina-based ceramic, and the separation membrane was modified, by respective procedures similar to those of Example 1.

### Example 3

A preparation solution and a separation membrane-forming alkoxide solution (mixture solution) were formulated by respective procedures similar to those of Example 1, according to materials and their amounts described in Table 1.

A modification treatment solution (treatment solution) was formulated by a procedure similar to that of Example 1.

A separation membrane having the polysiloxane network structure was formed on a surface of a pipe-like object of an alumina-based ceramic, and the separation membrane was modified, by respective procedures similar to those of Example 1.

### Example 4

A preparation solution was formulated by a procedure similar to that of Example 1, according to materials and their amounts described in Table 1. A separation membrane-forming alkoxide solution (mixture solution) was formulated by a procedure similar to that of Example 1, except that magnesium nitrate hexahydrate was not added.

A modification treatment solution (treatment solution) was formulated by a procedure similar to that of Example 1.

A separation membrane having the polysiloxane network structure was formed on a surface of a pipe-like object of an alumina-based ceramic, and the separation membrane was modified, by respective procedures similar to those of Example 1.

### Example 5

A preparation solution was formulated by a procedure similar to that of Example 1, according to materials and their amounts described in Table 1. A separation membrane-forming alkoxide solution (mixture solution) was formulated by a procedure similar to that of Example 1, except that magnesium nitrate hexahydrate was not added.

A modification treatment solution (treatment solution) was formulated by a procedure similar to that of Example 1, except that dimethyldiethoxysilane was used as a modifying silane compound.

A separation membrane having the polysiloxane network structure was formed on a surface of a pipe-like object of an alumina-based ceramic, and the separation membrane was modified, by respective procedures similar to those of Example 1.

### Comparative Example 1

A preparation solution was formulated by a procedure similar to that of Example 1, according to materials and their amounts described in Table 1. Tetraethoxysilane was added to the preparation solution, followed by stirring for about 2 h. Moreover, magnesium nitrate hexahydrate was added to the preparation solution, followed by stirring for about 2 h, to formulate a separation membrane-forming alkoxide solution (mixture solution). Specifically, in Comparative Example 1, the separation membrane-forming alkoxide solution was formulated without methyltriethoxysilane, and therefore, only tetraethoxysilane undergoes a one-step sol-gel reaction.

A modification treatment solution (treatment solution) was formulated using a procedure similar to that of Example 1.

A separation membrane having the polysiloxane network structure was formed on a surface of a pipe-like object of an alumina-based ceramic, and the separation membrane was modified, by respective procedures similar to those of Example 1.

<Separation Performance Verification Test>

A test for verifying the carbon dioxide and methane gas separation performance of the separation membranes of Examples 1-5 and Comparative Example 1 was conducted. In the verification test, the carbon dioxide and methane gas separation performance was evaluated with reference to nitrogen. Here, nitrogen has a gas molecular size of 3.64 Å, carbon dioxide has a gas molecular size of 3.3 Å, and methane gas has a gas molecular size of 3.8 Å. Therefore, in a nitrogen/carbon dioxide mixture system, carbon dioxide, which has a smaller gas molecular size than that of nitrogen, more easily passes through a separation membrane. In a nitrogen/methane gas mixture system, methane gas, which has a larger gas molecular size than that of nitrogen, has more difficulty in passing through a separation membrane. If a characteristic (functional group) of a membrane is suitably set by utilizing such different properties of these gases, carbon dioxide or methane gas can be separated from the mixture system. In the verification test, the gas permeation rates of nitrogen, carbon dioxide, and methane gas before and after a modification treatment were compared with each other for each of the separation membranes of Examples 1-5 and Comparative Example 1. The test was performed as follows. Moisture was completely removed from the pores of a separation membrane (before and after a modification treatment) by vacuum drying for 1 h. The separation membrane was placed in a closed space, into which individual gases containing nitrogen, carbon dioxide, and methane gas, respectively, were caused to flow under a pressure of 0.1 MPa, and the permeation rate [mol/(m²×s (second)×Pa)] to each individual gas was measured. The result of the separation performance verification test is shown in Table 2.

TABLE 2

| | | | | | | | Comparative |
|---|---|---|---|---|---|---|---|
| | | Examples | | | | | example |
| | | 1 | 2 | 3 | 4 | 5 | 1 |
| Permeation rate before | P(N₂) | 4.38 × 10⁻¹¹ | 6.71 × 10⁻¹¹ | 4.13 × 10⁻¹¹ | 1.64 × 10⁻¹⁰ | 1.34 × 10⁻¹⁰ | 8.61 × 10⁻¹¹ |
| modification treatment | P(CH₄) | 6.52 × 10⁻¹¹ | 9.28 × 10⁻¹¹ | 2.99 × 10⁻¹¹ | 1.66 × 10⁻¹⁰ | 1.84 × 10⁻¹⁰ | 9.84 × 10⁻¹¹ |
| [mol/(m² × s (second) × Pa)] | P(CO₂) | 2.61 × 10⁻⁹ | 2.80 × 10⁻⁹ | 7.02 × 10⁻¹⁰ | 6.42 × 10⁻⁹ | 4.90 × 10⁻⁹ | 2.99 × 10⁻⁹ |
| Permeation rate ratio | α(CO₂/N₂) | 59.6 | 41.7 | 17.0 | 39.1 | 36.6 | 34.7 |
| | α(CO₂/CH₄) | 40.0 | 30.2 | 23.5 | 38.7 | 26.6 | 30.4 |
| Permeation rate after | P(N₂) | 1.73 × 10⁻¹⁰ | 1.14 × 10⁻¹⁰ | 3.75 × 10⁻¹¹ | 1.82 × 10⁻¹⁰ | 4.79 × 10⁻¹⁰ | 6.46 × 10⁻¹¹ |
| modification treatment | P(CH₄) | 4.65 × 10⁻¹⁰ | 2.81 × 10⁻¹⁰ | 2.87 × 10⁻¹¹ | 2.73 × 10⁻¹⁰ | 6.50 × 10⁻¹⁰ | 5.15 × 10⁻¹¹ |
| [mol/(m² × s (second) × Pa)] | P(CO₂) | 1.99 × 10⁻⁸ | 1.51 × 10⁻⁸ | 1.54 × 10⁻⁹ | 1.14 × 10⁻⁸ | 1.83 × 10⁻⁸ | 1.39 × 10⁻⁹ |
| Permeation rate ratio | α(CO₂/N₂) | 115.0 | 132.5 | 41.1 | 62.6 | 38.2 | 21.5 |
| | α(CO₂/CH₄) | 42.8 | 53.7 | 53.7 | 41.8 | 28.2 | 27.0 |

(1) For the separation membrane of Example 1 after the modification treatment, the permeation rates of nitrogen, carbon dioxide, and methane gas all increased, and the permeation rate ratio thereof also increased. It was demonstrated that, when the polysiloxane network structure is formed from tetraethoxysilane and methyltriethoxysilane at a mixing ratio of 6:4 (tetraethoxysilane:methyltriethoxysilane), the effect of the modification treatment using trimethylmethoxysilane is significant.

(2) For the separation membrane of Example 2 after the modification treatment, the permeation rates of nitrogen, carbon dioxide, and methane gas all increased, and the permeation rate ratio thereof also increased. It was demonstrated that, when the polysiloxane network structure is formed from tetraethoxysilane and methyltriethoxysilane at a mixing ratio of 6:4 (tetraethoxysilane:methyltriethoxysilane), the effect of the modification treatment using trimethylchlorosilane is significant.

(3) For the separation membrane of Example 3 after the modification treatment, the permeation rate of carbon dioxide particularly increased, and the permeation rate ratio thereof also increased. It was demonstrated that, even when the polysiloxane network structure is formed from tetraethoxysilane and methyltriethoxysilane at a mixing ratio of 9:1 (tetraethoxysilane:methyltriethoxysilane), the effect of the modification treatment using trimethylmethoxysilane is significant.

(4) For the separation membrane of Example 4 after the modification treatment, the permeation rate of carbon dioxide particularly increased, and the permeation rate ratio thereof also increased. It was demonstrated that, when the polysiloxane network structure is formed from tetraethoxysilane and methyltriethoxysilane at a mixing ratio of 4:6 (tetraethoxysilane:methyltriethoxysilane) even without magnesium nitrate hexahydrate being added, the effect of the modification treatment using trimethylmethoxysilane is significant.

(5) For the separation membrane of Example 5 after the modification treatment, the permeation rate of carbon dioxide particularly increased, and the permeation rate ratio thereof also increased. It was demonstrated that, when the polysiloxane network structure is formed from tetraethoxysilane and methyltriethoxysilane at a mixing ratio of 4:6 (tetraethoxysilane:methyltriethoxysilane) even without magnesium nitrate hexahydrate being added, the effect of the modification treatment using dimethyldiethoxysilane is significant. Note that, in Example 5, ethanol was used as the solvent of the modification treatment solution (treatment solution), and it was observed that the improvement of the permeation rate and permeation rate ratio due to the modification treatment tends to be lower than in the other examples 1-4 in which toluene was used. Therefore, as the solvent of the modification treatment solution (treatment solution), toluene is more preferable than ethanol.

(6) On the other hand, for the separation membrane of Comparative Example 1 after the modification treatment, the permeation rates of nitrogen, carbon dioxide, and methane gas slightly decreased, and the permeation rate ratio thereof also decreased. Specifically, it was suggested that when a separation membrane is formed by mixing only tetraethoxysilane, even if the modification treatment is performed, not only the polysiloxane network structure is not efficiently modified, but also the modification treatment may adversely influence the separation performance.

Thus, it was demonstrated that the acid gas-containing gas treatment separation membrane of the present invention has good carbon dioxide or methane gas separation performance, and therefore, is considerably useful as a separation membrane for obtaining a gas having a high methane concentration from biogas generated by biologically treating garbage or the like.

### INDUSTRIAL APPLICABILITY

The acid gas-containing gas treatment separation membrane of the present invention, and the method for manufacturing the acid gas-containing gas treatment separation membrane of the present invention, are usable in equipment for manufacturing town gas, equipment for supplying hydrogen to fuel cells, and the like. Moreover, the present invention is applicable to gas emitted from a factory or power station, natural gas, gas which is a byproduct of oil refinery, and the like.

1. An acid gas-containing gas treatment separation membrane including a polysiloxane network structure having an introduced hydrocarbon group, wherein unreacted residual groups present on a surface of the polysiloxane network structure have been eliminated or reduced by reaction with at least one modifying silane compound selected from the group consisting of hydrocarbon group-containing monoalkoxysilanes, hydrocarbon group-containing dialkoxysilanes, hydrocarbon group-containing monochlorosilanes, hydrocarbon group-containing dichlorosilanes, and hydrocarbon group-containing trichlorosilanes.

2. The acid gas-containing gas treatment separation membrane of claim 1, wherein
the polysiloxane network structure having the introduced hydrocarbon group is a composite polysiloxane network structure obtained by reaction of a tetraalkoxysilane with a hydrocarbon group-containing trialkoxysilane containing the hydrocarbon group.

3. The acid gas-containing gas treatment separation membrane of claim 2, wherein
the tetraalkoxysilane is tetramethoxysilane or tetraethoxysilane (indicated by “A”), and
the hydrocarbon group-containing trialkoxysilane is a trimethoxysilane or triethoxysilane whose Si atom is bonded with an alkyl group having 1-6 carbon atoms or a phenyl group (indicated by “B”).

4. The acid gas-containing gas treatment separation membrane of claim 3, wherein
the mixing ratio (A/B) of the A to the B, expressed in a mole ratio, is 1/9-9/1.

5. The acid gas-containing gas treatment separation membrane of claim 1, wherein
the hydrocarbon group-containing monoalkoxysilane is a monomethoxysilane or monoethoxysilane whose Si atom is bonded with the same or different hydrocarbon groups, each of which is an alkyl group having 1-6 carbon atoms or a phenyl group, and
the hydrocarbon group-containing dialkoxysilane is a dimethoxysilane or diethoxysilane whose Si atom is bonded with the same or different hydrocarbon groups, each of which is an alkyl group having 1-6 carbon atoms or a phenyl group.

6. The acid gas-containing gas treatment separation membrane of claim 1, wherein
the hydrocarbon group-containing monochlorosilane is a monochlorosilane whose Si atom is bonded with the same or different hydrocarbon groups, each of which is an alkyl group having 1-6 carbon atoms or a phenyl group,
the hydrocarbon group-containing dichlorosilane is a dichlorosilane whose Si atom is bonded with the same or different hydrocarbon groups, each of which is an alkyl group having 1-6 carbon atoms or a phenyl group, and
the hydrocarbon group-containing trichlorosilane is a trichlorosilane whose Si atom is bonded with a hydrocarbon group which is an alkyl group having 1-6 carbon atoms or a phenyl group.

7. A method for manufacturing an acid gas-containing gas treatment separation membrane, comprising:
(a) a preparation step of formulating a preparation solution containing a mixture of an acid catalyst, water, and an organic solvent, and a treatment solution containing a mixture of an acid catalyst, an organic solvent, and at least one modifying silane compound selected from the group consisting of hydrocarbon group-containing monoalkoxysilanes, hydrocarbon group-containing dialkoxysilanes, hydrocarbon group-containing monochlorosilanes, hydrocarbon group-containing dichlorosilanes, and hydrocarbon group-containing trichlorosilanes;
(b) a first mixing step of mixing the preparation solution with a tetraalkoxysilane;
(c) a second mixing step of mixing the mixture solution obtained in the first mixing step with a hydrocarbon group-containing trialkoxysilane;
(d) a first application step of applying the mixture solution obtained in the second mixing step to an inorganic porous support member;
(e) a formation step of performing a thermal treatment on the inorganic porous support member after completion of the first application step, to form a polysiloxane network structure having an introduced hydrocarbon group on a surface of the inorganic porous support member;
(f) a second application step of applying the treatment solution to a surface of the polysiloxane network structure; and
(g) a reaction step of performing a thermal treatment on the polysiloxane network structure after completion of the second application step, and causing unreacted residual groups present on a surface of the polysiloxane network structure to react with the modifying silane compound contained in the treatment solution, to eliminate or reduce the unreacted residual groups.

8. The method of claim 7, wherein
the preparation step includes adding a metal salt having affinity for acid gas to the preparation solution.

9. The method of claim 7, wherein
in the first mixing step, the tetraalkoxysilane is tetramethoxysilane or tetraethoxysilane (indicated by “A”), and
in the second mixing step, the hydrocarbon group-containing trialkoxysilane is a trimethoxysilane or triethoxysilane whose Si atom is bonded with an alkyl group having 1-6 carbon atoms or a phenyl group (indicated by “B”).

10. The method of claim 9, wherein
the mixing ratio (A/B) of the A to the B, expressed in a mole ratio, is 1/9-9/1.
